(19) United States
(12) Patent Application Publication
(10) Pub. No.: US 2015/0120796 A1
(43) Pub. Date: Apr. 30, 2015

(54) Standing wave simple math processor

(71) Applicant: Seth John Winnipeg, Regina (CA)

(72) Inventor: Seth John Winnipeg, Regina (CA)

(21) Appl. No.: 14/594,072

(22) Filed: Jan. 9, 2015

(51) Int. Cl. G06F 1/02

(52) U.S. Cl. CPC G06F 1/022
USPC 708/204; 708/490; 708/200

(57) ABSTRACT

The standing wave simple math processor is a new system for doing simple math (addition). By utilizing standing waves and conventional connections, a charge of direct current is transferred from 2 adjacent standing waves to 1 final standing wave representing the output. In essence the two input waves function as operands in a math problem. The operator, in this sense, is an interconnection of DC current between the 3 standing waves, as well as a set of redistribution rules. The final solution is retrieved upon completion of the redistribution rules.

This invention is the ‘standing wave simple math processor’. The inventor is Seth Winnipeg, Canadian citizen currently living in Regina, Saskatchewan, Canada.

### CROSS-REFERENCE TO RELATED APPLICATIONS

Not applicable

### BACKGROUND OF THE INVENTION

The standing wave simple math processor is a new system of doing the fundamental math inherent to all digital computation. Current methods of math processing done by computational devices are Boolean logic based.

Boolean logic relies on yes or no truth tables to create basic math. Boolean functions use logic gates to consistently and predictably convert an input to an output. By connecting these gates to one another and having multiple assemblies of these gates Boolean functions can do basic math. The two biggest weaknesses of this system is the inefficiency of both the base doing the math, and the amount of energy lost to heat. Boolean logic relies on base 2 which is a very inefficient way of expressing numbers per digit. As for lost energy, every time a logic circuit converts a ‘1’ to a ‘0’ it converts electrical energy into heat. Heat is the single biggest limiting factor to modern computation machines.

The standing wave simple math processor overcomes both of these problems. Electrical energy loss to heat would be radically reduced, also the magnitude of digit efficiency in its math would increase substantially. The intent of this invention is then not an improvement upon the existing Boolean logic based system, rather, it is intended to be a replacement for the entire Boolean logic based system.

### BRIEF SUMMARY OF THE INVENTION

The standing wave simple math processor does math by re-balancing a deteriorated standing wave. This deterioration is done for the purpose of number input. By having the standing wave change form (destabilize) my method of re-stabilization can consistently and predictably convert an input to an output in a similar fashion to Boolean logic gates. A major difference however, is that in this system the math is done directly, rather than a series of logic gates. The greatest benefit of this direct math is that I can take two inputs and produce a single output, much the same as a basic addition problem.

The standing wave simple math processor then has two strong advantages over the current method. Boolean logic depends on binary for expressing numbers, that is base 2. For this standing wave simple math processor it became possible to use a higher base, base 7. This new system can now pack more numerical information per base unit, contributing greatly to processor efficiency. The other and biggest advantage is that now there is no bleeding of electrical to thermal energy. Since the standing waves are designed to be stabilized/destabilized via DC, thermal energy loss is at a minimum and not designed into the regular function of the system.

### BRIEF DESCRIPTION OF THE SEVERAL VIEWS OF THE DRAWING

FIG. 1 is a diagram illustrating the creation of a standing wave

FIG. 2 is a diagram showing the placement of a dielectric around the transmission line of the standing wave.

FIG. 3 is a diagram showing the I/O leads, and their proximity to the dielectric. It is implied that The I/O leads would have a connection to a DC source.

FIG. 4 is a diagram to show the relationship between the previous models of a standing wave anti-node and the model used for the remainder of the specification.

FIG. 5 is an illustration showing digit representation. The use of position number (pos.) is subject to the digit being processed and is not to be construed as an absolute.

FIG. 6 is an illustration showing the three anti-nodes lines in relation to each other, also shown is the position number.

FIG. 7 is an illustration showing the relationship of position number, anti-node value written as [‘x’], and EU value.

FIG. 8 is an illustration showing the lattice structure between AL1 and AL3, AL2 and AL3 and finally a superposition of both AL1 and AL2 connecting to AL3.

FIG. 9 is an illustration of the 4 sequential rules of valence movement followed by an illustration for each rule.

FIG. 10 is a 4 phase breakdown of the standing wave simple math processor; input, followed by lattice movement, followed by valence movement, and finally output.

### DETAILED DESCRIPTION OF THE INVENTION

The standing wave simple math processor is a custom designed base 7 math system built to integrate into 3 standing waves running through a capacitance field.

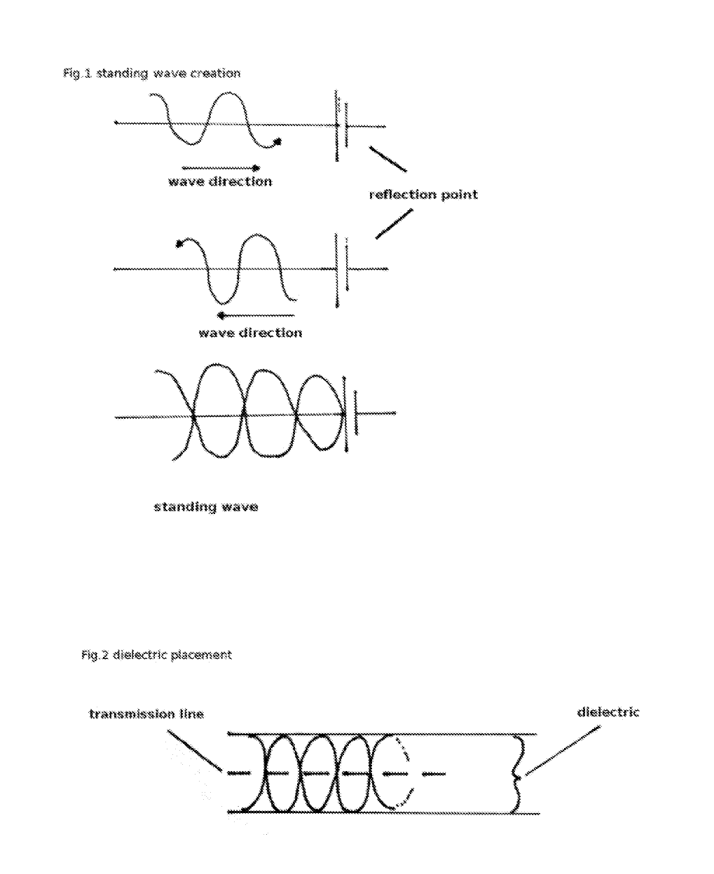

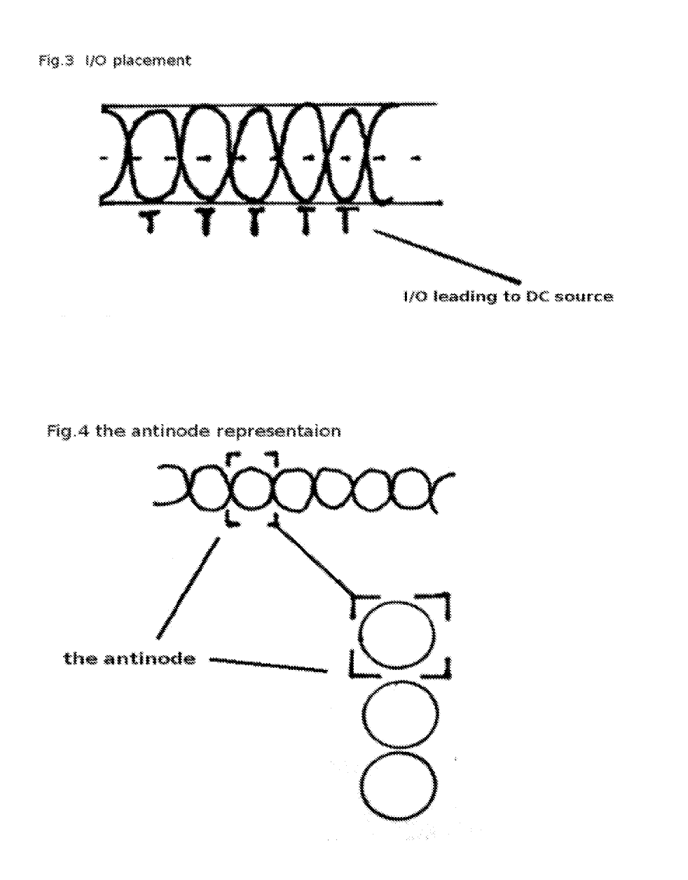

The standing wave (SW) is created by transmitting alternating current along a conduction line (wire) and then having it reflected upon itself.[FIG. 1] In perfect balance, a SW has no net propagation of energy. Standing waves create rising and falling areas at the anti-nodes. Utilizing these properties it is the intention to introduce imbalances at these anti-nodes. By having the SW travel through a dielectric it will be possible to to influence the anti-nodes.[FIG. 2] Dielectrics are a component of capacitors, indeed the intention of this system is to make a SW inside a dielectric, which will allow a DC interaction with an AC wave. DC current interacting with an AC field is critical to the standing wave simple math processor.

By introducing a DC current to the AC field at the anti-node the standing wave will become unstable. In normal conditions an unstable standing wave would deteriorate and lose its energy. By fixing, in this case, re-stabilizing the SW before the reflection point, the SW could be preserved. I propose using a DC source to add or remove DC charges at anti-nodes. DC added or removed at the anti-node would in effect be able to re-balance the SW. The inverse is also true that this method would be able to destabilize the SW as well. This in-out (I/O) method would be used to move DC charges to and from the anti-nodes. [FIG. 3] As I will illustrate in the next section these DC charges will represent elements of numerical digits and be instrumental to the processing of math in this system.

For the purpose of number creation in this system a few elements need to be explained. In this system I will use base 7. To express base 7 numbers I need to construct them from 3 anti-nodes, that is to say: Any one base 7 digit is comprised of 3 consecutive anti-nodes. The first anti-node represents ‘1’ and the second ‘2’ and the third ‘3’. In this manner, if an anti-node has a DC charge present at the first and third anti-node the number it represents is ‘4’. see [FIG. 5] for a more complete illustration of digit composition.

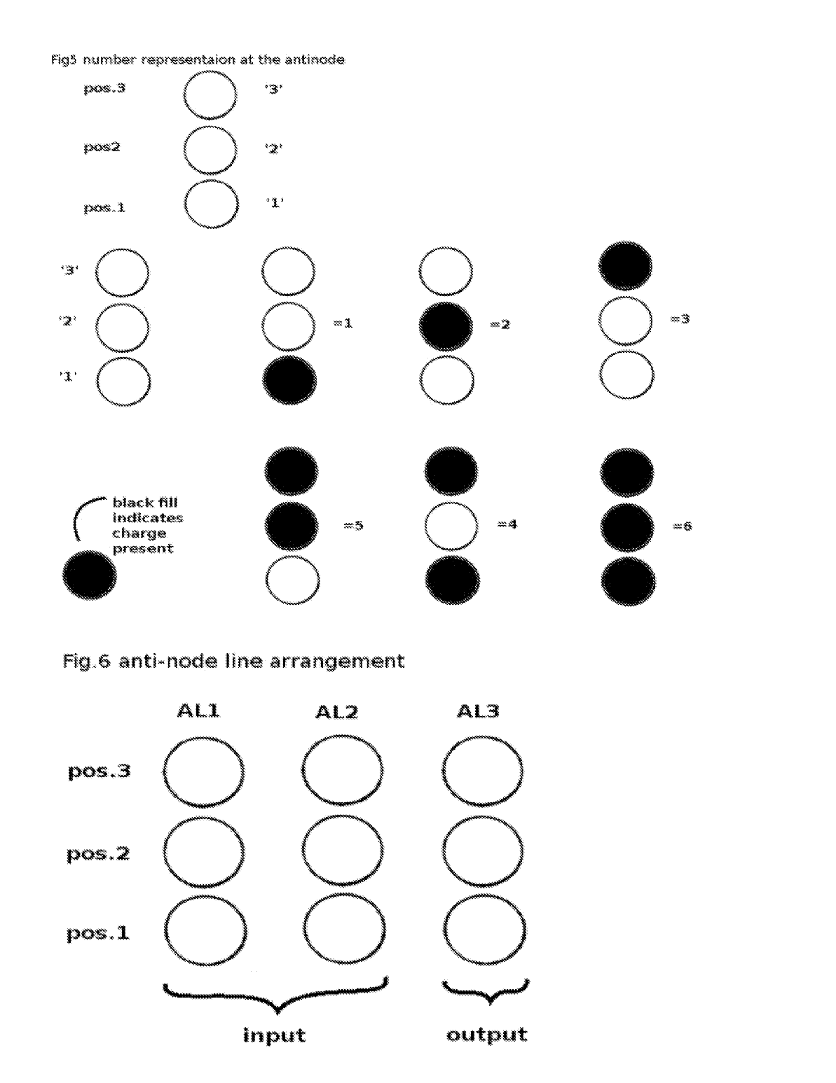

The minimum number of anti-nodes are dependant on the digit size of the desired math, and/or the physical length of the SW itself. Therefore, these strings of anti-nodes will be referred to as anti-node lines (AL). Each AL is itself a SW with an I/O at each of its anti-nodes. As will be explained shortly, the standing wave simple math processor requires at least 3 ALs to process math. AL1 and AL2 will function as inputs and AL3 will function as the output. [FIG. 6]

For sake of clarity, these DC charges will be referred to as electron units (EU). EUs are the lowest possible unit of DC charge that can be used in this system. Obviously, as technology gets better and these physical systems are improved upon the actual DC charge will get smaller and more efficient until the smallest possible unit would be 1 electron. For our concerns though the EU is rather arbitrary and is representative of the smallest possible unit of charge in this system.

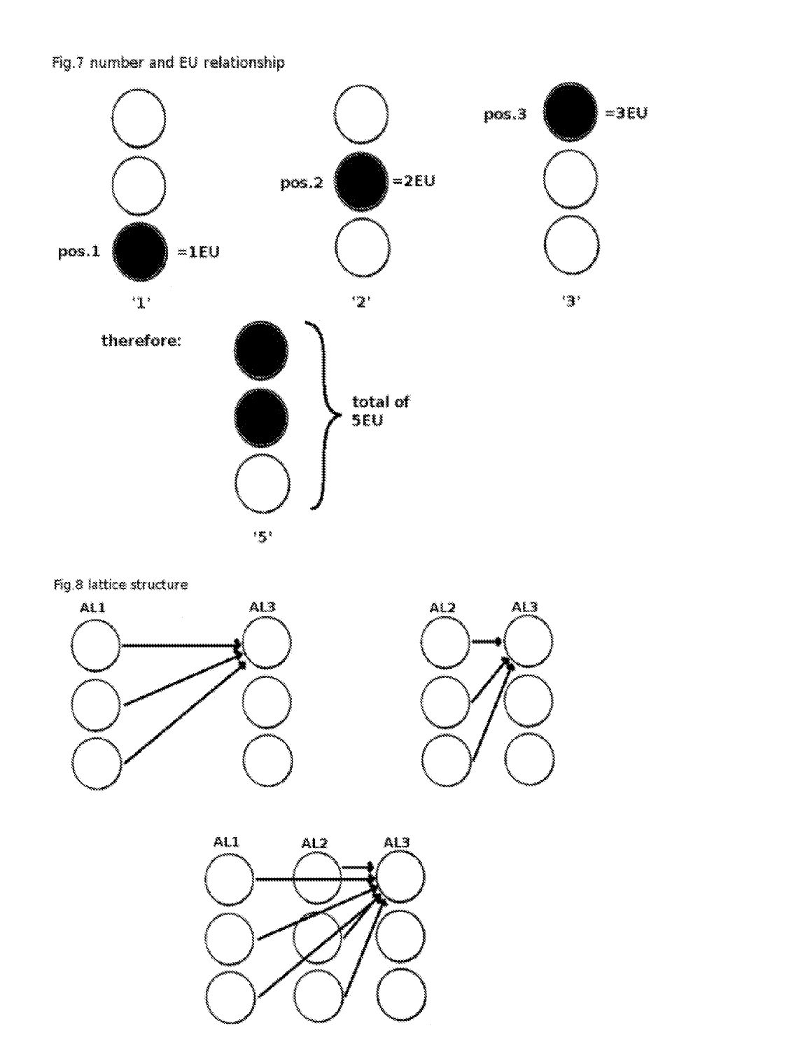

The critical element at this point then, is the relationship between digit values at the anti-nodes and the amount of EU present. at each anti-node in sequence, a corresponding EU must be present. That is in order to represent ‘2’ 2 EUs must be present at that particular anti-node see [FIG. 7]. Although it seems redundant to have the number of EUs also represent the number itself it is wholly necessary for later stages.

Basic math requires both operator and operand. In this case the operand is the number defined by EUs at the anti-nodes. The operator function is divided between lattice movement and valence movement. For the purposes of simplicity this specification will refer to the various positions of the AL. see FIGS. 5, and 6 again. It must be noted that these numbering conventions are completely relative and change to relate to the particular digit being processed. In brief this means that references to position number (pos.) are accurate only when that digit is being processed. As this system is capable of dealing with any number of digits the position naming convention as supplied is only applicable as that particular digit is being examined.

Lattice movement in brief is the transfer of any EUs along the input ALs to the output AL. [FIG. 8] The lattice is simply an interconnection of AL1 and AL2's individual anti-nodes to AL3 pos.3, allowing the transfer of EU charges to be deposited at that location. This transfer has a secondary effect of instantly balancing both AL1 and AL2. This is done because any EU present on the AL will put it into unbalance, therefore removing those EUs will return the AL into a ‘0’ charge state or ‘balance’. The benefits of this cannot be understated, as a necessary process both AL 1 and AL2 have achieved a balanced state even before final output is achieved.

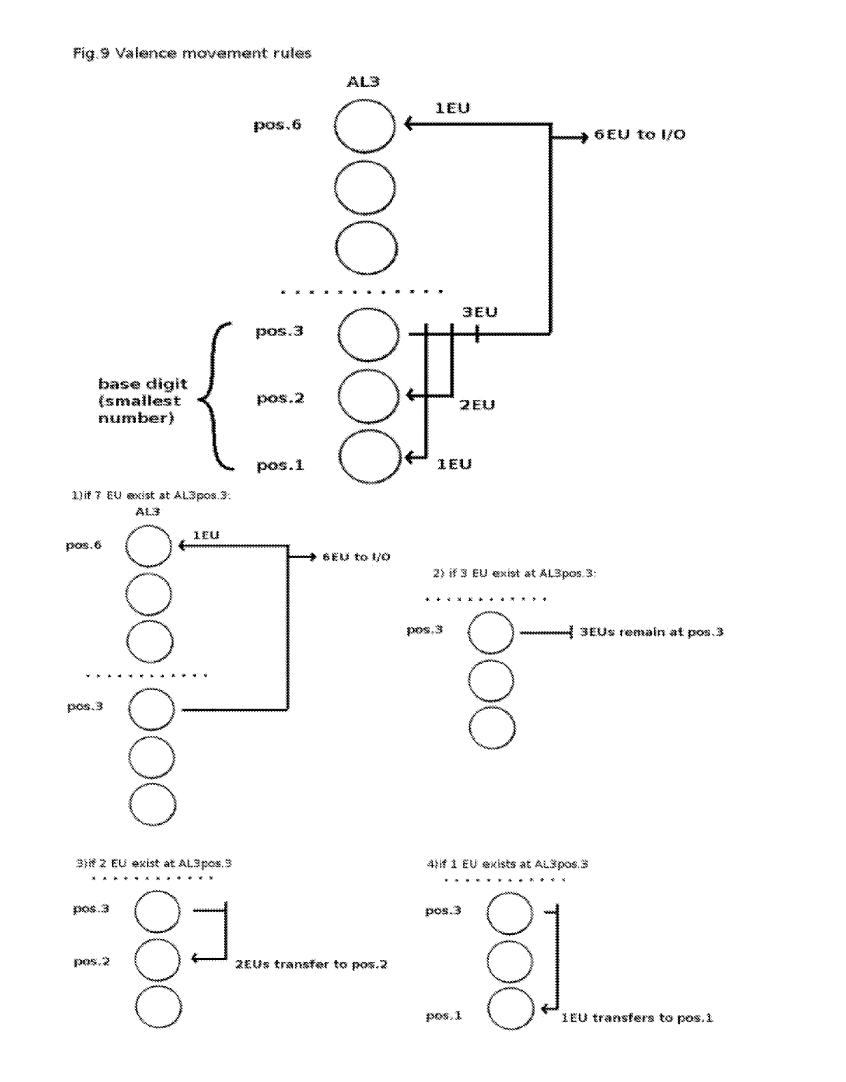

The second phase of the operator function is valence movement. Valence movement, in essence, is a set of 4 logical rules for the redistribution of EUs present at AL3pos.3. After lattice movement has taken place, there is now a deposit of EUs at AL3pos.3 this deposit is not necessarily compatible with the base 7 numbering system, as such it must be redistributed. Redistribution, or valence movement, is governed by the number of EUs present at AL3pos.3 in order from largest to least. This governing can be expressed as 4 logical rules dependent on order; [FIG. 9]
1) If the number of EUs at AL3pos.3 number 7, then 6 EUs will be recycled via I/O with the remaining 1 EU moved to the next digit up (AL3pos.6). 2) If the number of EU at AL3pos.3 number 3 then that quantity will remain at AL3pos.3. 3) If the number of EU at AL3pos.3 number 2 then that quantity will move entirely to AL3pos.2. 4) If the number of EU at AL3pos.3 number 1 EU then that quantity will move to AL3pos.1.

Of important note in this system is that the logical operations are magnitude dependant, as such all four rules must be followed sequentially as to ensure accurate redistribution. Also of strict importance is which digit to process first. Since these digits process math dependent upon the preceding digit, then logically the first digit to be processed must be the digit of least value. In other words, the operator function can only proceed when the digit represented ‘beneath’ it is already completed, or is ‘0’. In this manner then there is no limit to how many digits can be involved in the math operation, so long as the first digit to have the been processed is the digit of least value.

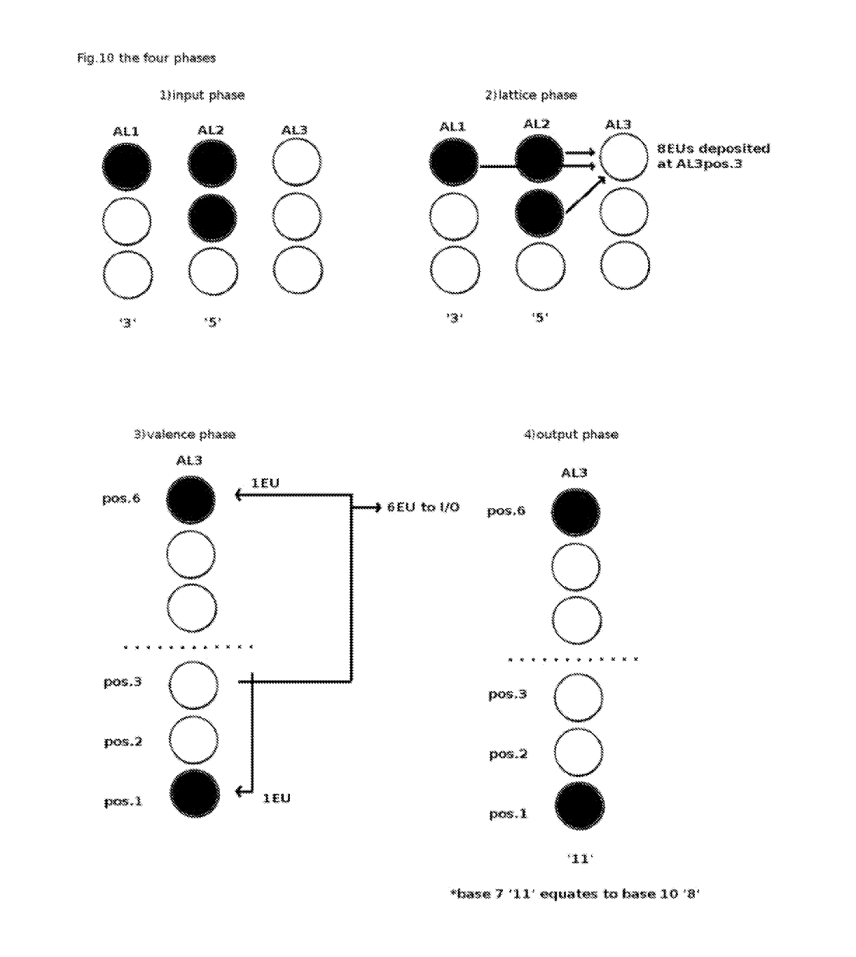

To conclude then, this system uses 3 ALs to do math. AL 1 and 2 are used to create the operands (input). AL3 serves as the output. An I/O provides both the input of EU values as well as a recycling source for the re-balance of ALs. By using a lattice interconnection of all the input anti-nodes to AL3pos.3, AL1 and AL2 now reach a state of balance after the initial unbalancing of EU input. The lattice movement results in a transfer of EU to a single point on the output SW (AL3). Using the valence movement rules stated above, these EUs can now be sorted into AL3 for the purpose of output comprehension (producing a final output solution). Please see [FIG. 10] for a comprehensive breakdown of this summary.

1. A basic math function performed by the manipulation of an alternating current wave form in a dielectric by a direct current.

2. A system for representing numbers as a type of destabilized standing wave.

3. An operator function as a set of rules for the transfer and distribution of DC charges from input wave forms to an output waveform.
